(19) United States
(12) Patent Application Publication
(10) Pub. No.: US 2007/0274532 A1
(43) Pub. Date: Nov. 29, 2007

(54) Audio Reproduction Device, Audio System and Audio Delivery Device

(75) Inventors: Hiroyuki Adachi, Tokyo (JP); Masayuki Iwata, Tokyo (JP)

Correspondence Address: FISH & RICHARDSON P.C., P.O. BOX 1022, MINNEAPOLIS, MN, 55440-1022, US

(73) Assignee: SANYO ELECTRIC CO., LTD., Osaka (JP)

(21) Appl. No.: 11/419,959

(22) Filed: May 23, 2006

(51) Int. Cl. H04B 3/00; G05B 11/01

(52) U.S. Cl. 381/77; 340/310.11

(57) ABSTRACT

An audio reproduction device comprising a PLC unit for receiving communications signals of power line communications transmitted through a power line and outputting digital audio data included in the communications signals, an audio signal generation circuit for generating analog audio signals based on the digital audio data, a power supply circuit for generating a drive voltage for each of the PLC unit and the audio signal generation circuit based on a commercial power supplied from the power line, and a speaker for outputting sounds based on the analog audio signals.

### BACKGROUND OF THE INVENTION

1. Field of the Invention

The present invention relates to an applied technology of power line communications (hereinafter, also referred to as “PLC”), and specifically relates to an audio reproduction device, an audio system and an audio delivery device.

2. Description of the Related Art

In recent years, legislation has been developed with respect to power line communications. In addition, in some nations, the power line communications have been already put into practice.

Incidentally, one advantage of using the power line communications is that existing power lines can be used as communications lines. With regard to projects of manufacturing products using the power line communications, a way how to utilize the above-mentioned advantage for usability and appearance of the products, for example, is a key in addition to technical viewpoints thereof.

### SUMMARY OF THE INVENTION

The present invention provides an audio reproduction system, an audio system and an audio delivery device, which apply power line communications.

An aspect of the present invention is a audio reproduction device comprising a PLC unit for receiving communications signals of power line communications transmitted through a power line and outputting digital audio data included in the communications signals; an audio signal generation circuit for generating analog audio signals based on the digital audio data; a power supply circuit for generating a drive voltage for each of the PLC unit and the audio signal generation circuit based on a commercial power supplied from the power line; and a speaker for outputting sounds based on the analog audio signals.

The audio reproduction device is configured to reproduce digital audio data transmitted thorough the power line, and is configured to obtain a drive voltage for reproducing digital audio data based on commercial power supplied from the power line. For this reason, it is not necessary to run audio and power cables as it is required for a conventional audio device. Accordingly, in a case of setting the device in a room or the like, the image of the room or the like is not impaired. Further, the audio reproduction device of the present invention has an innovative and unique configuration in which the device can be used while being attached to a bulb socket. For this reason, the device also has design characteristics for interior and entertainment characteristics as a product.

### BRIEF DESCRIPTIONS OF THE DRAWINGS

For a more complete understanding of the present invention and the advantages thereof, reference is now made to the following description taken in conjunction with the accompanying drawings.

FIG. 1 is a diagram showing a configuration of an audio system 1 using power line communications which will be described as an embodiment of the present invention.

FIG. 2 is a diagram showing a configuration of an information processing device 11 which will be described as the embodiment of the present invention.

FIG. 3 is a diagram showing a configuration of a PLC unit 12 which will be described as the embodiment of the present invention.

FIG. 4 is a diagram showing a configuration of a microcomputer 22 which will be described as the embodiment of the present invention.

FIG. 5 is a diagram showing a configuration of a decoder unit 23 which will be described as the embodiment of the present invention.

FIG. 6 is a diagram showing another configuration of the microcomputer which 22 will be described as the embodiment of the present invention.

FIG. 7 is a diagram showing a still another configuration of the microcomputer 22 which will be described as the embodiment of the present invention.

FIG. 8 is a diagram showing a connection device 80 which will be described as the embodiment of the present invention.

FIG. 9 is a diagram showing an example of an audio reproduction device 20 of built-in speaker type, which will be described as the embodiment of the present invention.

FIG. 10 is a diagram showing another configuration of the audio reproduction device 20 of built-in speaker type, which will be described as the embodiment of the present invention.

FIG. 11 is a diagram showing a state where the audio reproduction device 20, which will be described as the embodiment of the present invention, is attached to a bulb socket 98 of a floor lamp 96.

FIG. 12 is a diagram showing a configuration of an audio reproduction device 20 of built-in speaker type including a lighting function, which will be described as the embodiment of the present invention.

FIG. 13 is a diagram showing a configuration of an audio system 1 which adopts a system for supplying digital audio data by an analog audio device, which will be described as the embodiment of the present invention.

### DETAILED DESCRIPTION OF THE INVENTION

Hereinafter, with reference to the attached drawings, descriptions will be provided for a preferred embodiment of an audio reproduction device, an audio system and audio delivery device acceding to the present invention.

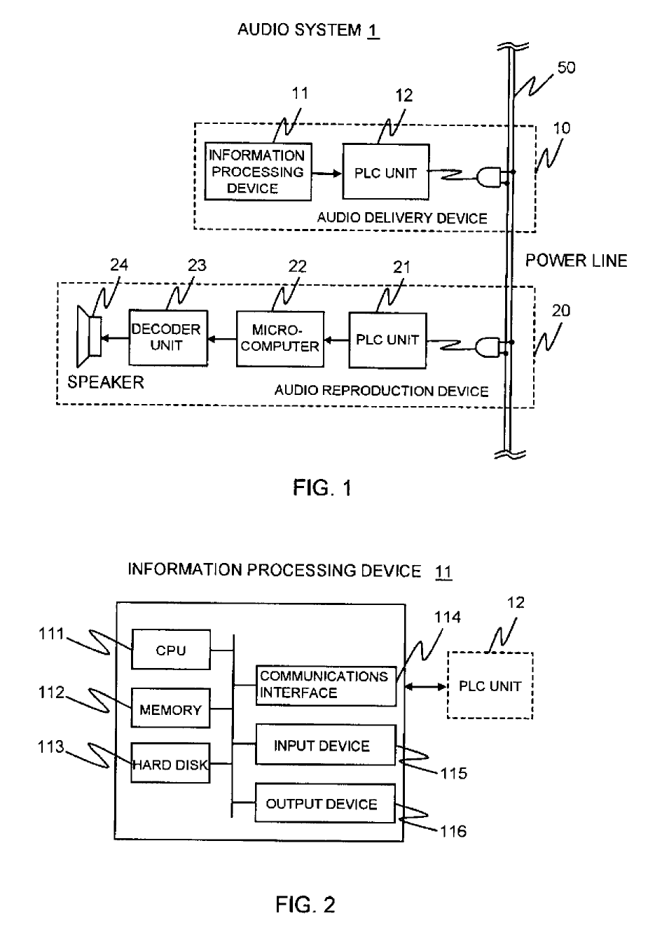

FIG. 1 shows a configuration of an audio system 1 using power line communications, which will be described as the embodiment of the present invention. The audio system 1 is configured of an audio delivery device 10 and an audio reproduction device 20. The audio delivery device 10 outputs communication signals of power line communications (hereinafter, referred to as PLC signals) to a power line 50, the communications signals including audio data which are data obtained by encoding audio signals such as a music. The audio reproduction device 20 reproduces sounds based on the audio data included in the PLC signals.

The audio delivery device 10 includes; an information processing device 11 such as a personal computer which supplies audio data; and a PLC unit 12 which is a circuit for converting the audio data, which are supplied from the information processing device 11, into PLC signals.

FIG. 2 shows a configuration of the information processing device 11. As shown in FIG. 2, the information processing device 11 includes a CPU 111, a memory 112, a hard disk 113, a communication interface 114 which communicates with the PLC unit 12, an input device 115 such as a keyboard and a mouse, and an output device 116 such as a CRT (cathode-ray tube) display and a liquid crystal monitor. Note that the communications interface 114 is an interface complying with a certain standard such as USB (Universal Serial BUS), RS-232 and the like.

In the information processing device 11, an operating system operates. A hard disk 113 of the information processing device 11 stores at least one file formatted in accordance with the MP3 (MPEG-1 Audio Layer-III) standard and the like (hereinafter, referred to as a “digital audio file”).

The memory 112 or the hard disk 113 stores a program for performing audio reproduction to output bitstream data to the PLC unit 12 based on the digital audio file stored in the hard disk 113 (hereinafter, referred to as a “audio reproduction program”). The audio reproduction by use of the audio reproduction program is performed in response to input of various operations by a user, the input being performed to the input device 115. The operations relating to the reproduction include “play”, “stop”, “pause”, “forward skip”, “backward skip”, “fast forward”, and “rewind”.

Incidentally, as an specific example of the audio reproduction program, there has been application software (a music player) for playing a digital audio file of musical sound stored in the hard disk 113, a CD-ROM or the like, the application software being installed in a computer such as a personal computer to be used.

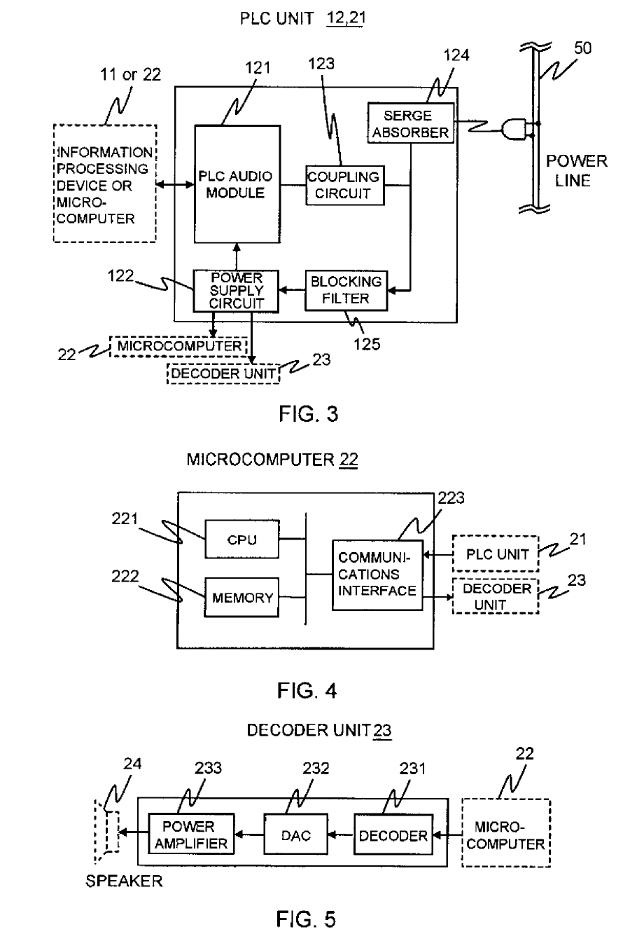

FIG. 3 shows a configuration of the PLC unit 12. The PLC unit 12 includes a PLC audio module 121, a power supply circuit 122, a coupling circuit 123, a serge absorber 124 and a blocking filter 125.

To the PLC audio module 121 among them, digital audio data, which are supplied from the information processing device 11 and are composed of a format such as I2S (Inter-IC Sound Bus), are inputted in a bitstream format. The PLC audio module 121 converts the inputted digital audio data into PLC signals modulated by a scheme such as OFDM (Orthogonal Frequency Division Multiplexing). The PLC audio module 121 includes a CPU, a memory, a communications interface circuit to communicate with the information processing device 11, and an analog front-end circuit provided on a side of a power line 50, and the like. As described below, the PLC audio module 121 also has a function to output digital audio data, which are included in PLC signals supplied from the power line 50, in the bitstream format to a microcomputer 22. In addition, the PLC audio module 121 also has a function to correct errors on PLC signals to be outputted/inputted from/to the power line 50.

The coupling circuit 123 is a circuit for coupling up the PLC audio module 121 to the power line 50. The coupling circuit 123 includes a filter circuit and an impedance matching circuit. The filter circuit causes only signals in a frequency band of the PLC signals (for example, 2 MHz to 20 MHz) to pass therethrough, and the impedance matching circuit matches an input impedance of the PLC audio module 121 to an impedance of the power line 50.

The power supply circuit 122 is a circuit for generating a voltage to drive the PLC audio module 121, based on an AC voltage supplied from the power line 50. In addition, the blocking filter 125 is a filter circuit for causing only frequency components (for example, 50 Hz and 60 Hz) of commercial power to pass therethrough in order that no PLC signal is inputted to the power supply circuit 122. The surge absorber 124 is a circuit which prevents an abnormal voltage (a surge voltage) generated by thunder or the like from being inputted to the inside of the PLC unit 12.

On the other hand, as shown in FIG. 1, the audio reproduction device 20 is configured by including the PLC unit 21, the microcomputer 22, the decoder unit 23 and a speaker 24. The microcomputer 22 and the decoder unit 23 constitutes a circuit for generating analog audio signals based on digital audio data (hereinafter, also referred to as “audio signal generation circuit”). The PLC unit 21 among them has a similar configuration to that of the PLC unit 12 of the audio delivery device 10 shown in FIG. 3.

Note that, on the contrary to the PLC audio module 121 of the PLC unit 12, a PLC audio module 121 of the PLC unit 21 operates to output digital audio data, which are included in PLC signals supplied from the power line 50, in the bitstream format to the microcomputer 22. In addition, a power supply circuit 122, which constitutes the PLC unit 21 in the audio delivery device 20, supplies a drive voltage to each of the microcomputer 22 and the decoder unit 23 in addition to the PLC audio module 121.

FIG. 4 shows an example of the microcomputer 22 constituting the audio signal generation circuit. The microcomputer 22 includes a CPU 221, a memory 222 and a communications interface 223 to communicate with the PLC unit 21. The microcomputer 22 transfers digital audio data to the decoder unit 23 in the bitstream format which are inputted from the PLC unit 21.

FIG. 5 shows a configuration of the decoder unit 23. The decoder unit 23 includes a decoder 231, a D/A converter (hereinafter, referred to as a “DAC 232”) and a power amplifier 233. The decoder 231 generates digital data by decoding the digital audio data inputted in the bitstream format from the microcomputer 22 and outputs the generated digital data to the DAC 232. The digital data are, for example, data in a PCM (Pulse Coded Modulation) format or in an ADPCM (Adaptive Differential Pulse Coded Modulation) format. The DAC 232 converts the digital data, which are inputted from the decoder 231, into analog audio signals. The power amplifier 233 amplifies the analog audio signals converted by the DAC 232 and outputs the analog audio signals to the speaker 24.

Note that the decoder unit 23 can have a configuration which does not include the power amplifier 233. In this case, the power amplifier 233 may be included, for example, inside the speaker 24.

Next, descriptions will be provided for specific operations of the audio system 1 having the above-described configuration. The information processing device 11 of the audio delivery device 10 starts processing for audio reproduction, for example, upon receipt of operation input for starting audio reproduction (hereinafter, referred to as a “audio reproduction processing”) from the input device 115.

In this audio reproduction processing, first, the CPU 111 of the information processing device 11 reads digital audio file from the hard disk 113 to the memory 112. Next, the CPU 111 starts outputting the inputted digital audio data in the bitstream format to the PLC unit 12 based on the digital audio file which has been read to the memory 112.

The digital audio data inputted in the bitstream format to the PLC unit 12 are inputted to the PLC audio module 121. The PLC audio module 121 outputs the PLC signals based on the inputted digital audio data to the power line 50.

The PLC signals outputted to the power line 50 are inputted to the PLC unit 21 of the audio reproduction device 20. The PLC unit 21 outputs the digital audio data in the bitstream format based on the inputted PLC signals. The digital audio data are inputted to the decoder unit 23 by the microcomputer 22.

The digital audio data which have been inputted to the decoder unit 23 are converted into digital data by the decoder 231. Thereafter, the digital data are converted into analog audio signals by the DAC 232 and are inputted to the power amplifier 233. After that, the analog audio signals which have been amplified by the power amplifier 233 are supplied to the speaker 24. Accordingly, sounds are outputted from the speaker 24.

According to the audio system 1 described above, the audio delivery device 10 is connected to, for example, the indoor power line 50, and the audio reproduction device 20 is connected to an indoor outlet. Accordingly, sounds provided from the audio delivery device 10 can be reproduced by the audio reproduction device 20. In other words, according to the audio system 1, it is possible to install an audio system without impairing a room image because it is not necessary to set audio and power cables, although in case of conventional audio systems, these cables are required to be set.

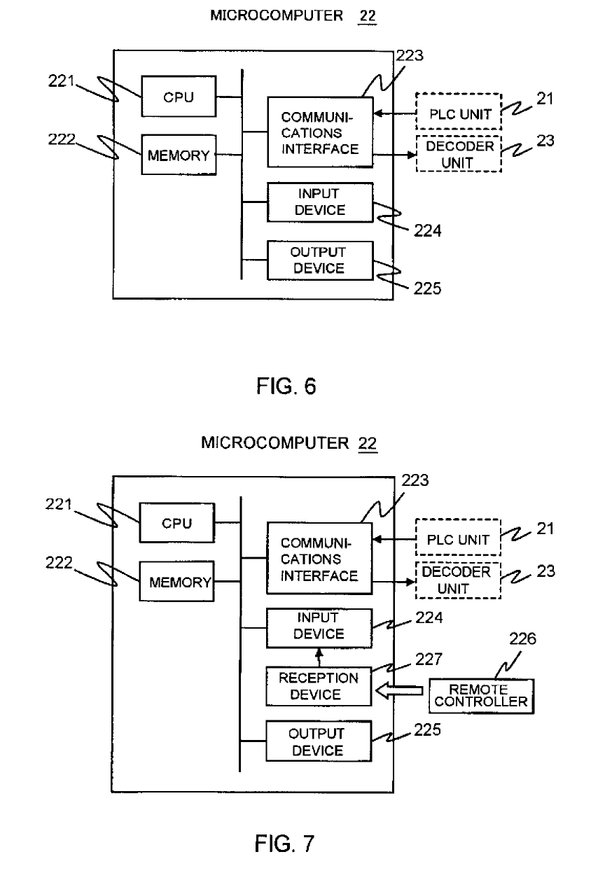

Incidentally, in the above-described audio system 1, operation input by a user for a command relating to the reproduction such as “play”, “stop”, “pause”, “forward skip”, “backward skip”, “fast forward”, and “rewind”, is possible to be performed in the information processing device 11 by utilizing functions of the audio reproduction program. However, it is also possible to perform the operation input in the audio reproduction device 20. In this case, for example, as shown in FIG. 6, an input device 224 and an output device 225 are connected to the microcomputer 22 of the audio reproduction device 20. Accordingly, it becomes possible for a user to perform operation input on the input device 224, and to display information on the operation input on the output device 225. Additionally, contents of the operation input (for example, a control command) are outputted from the microcomputer 22 to the PLC unit 21, and the PLC unit 21 outputs the contents of the input operations as PLC signals to the power line 50. Subsequently, the audio delivery device 10 receives the above-mentioned PLC signals and notifies the information processing device 11 of the contents of the operation input included in the PLC signals. Thereafter, in the information processing device 11, audio reproduction processing is performed in response to the notified contents of the operation input.

The operation input for a command relating to the reproduction can be performed by the user's operation of a remote controller. In this case, as shown in FIG. 7, the input device 224 is provided with a reception device 227 which receives radio signals (light, radio wave or the like) transmitted from the remote controller 226. Accordingly, contents of operation input included in the signals which have been received by the reception device 227 are converted into PLC signals, and the converted PLC signals are transmitted to the audio delivery device 10.

By adopting such a configuration that the operation input for a command relating to the reproduction is performed in the audio reproduction device 20, it is possible to improve convenience for users.

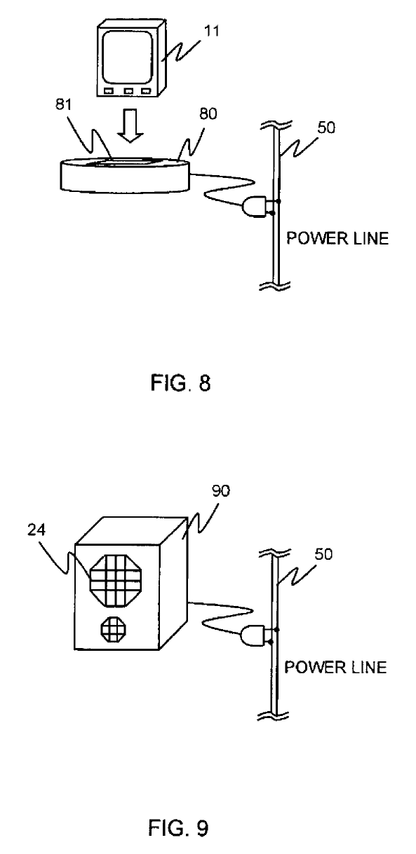

As the information processing device 11 of the audio delivery device 10, a stationary music player other than the personal computers described above can be used as a matter of course. In addition to this, for example, a portable device, such as a commercial PDA (Personal Digital Assistance), a portable music player, or a mobile phone having a music playing function, can be used as the information processing device 11. In this respect, in a case of using a portable device, it is possible to improve user convenience, for example, by using a connection device 80 which has a shape shown in FIG. 8, and in which the functions of the PLC unit 12 are integrated.

The connection device 80 shown in FIG. 8 is a so-called cradle device. The connection device 80 includes a connector 81 which connects the portable device and the audio module 121 of the PLC unit 12 and allows them to communicate with each other.

In the case of using the portable device as the information processing device 11, it suffices that a communication connector for the portable device is connected to the connector 81 of the connection device 80. In other words, by preparing the connection device 80 having such a configuration, it is made possible to use a portable device, such as the commercial PDA, the portable music player or the mobile phone having music playing function, can be used as the information processing device 11. Incidentally, the connection device 80 may be provided with a charging circuit of a secondary battery, whereby the built-in secondary battery in the information processing device 11 can be charged while the information processing device 11 is connected to the connection device 80.

It is also possible to deliver, from the audio delivery device 10, PLC signals on which a plurality of pieces of digital audio data are multiplexed, whereby a plurality of audio reproduction devices 20 connected to the power line 50 reproduces sounds different to one another. This system can be realized, for example, in a way that an identifier is attached to each of the plurality of pieces of the digital data delivered from the audio delivery device 10, and that the microcomputer 22 of each of the audio reproduction devices 20 selects a piece of the digital audio data attached a specific identifier and inputs the piece to the decoder 23 unit thereof. In this case, for example, when a transmission rate of the PLC signals is 4 Mbps and a transmission rate of one kind of the digital audio data is set to, for example, 192 kbps, at least four kinds of the digital audio data can be simultaneously delivered from the audio delivery device 10.

Additionally, a stereo audio system can be easily realized in a following manner. For example, the audio delivery device 10 multiplexes audio data with respect to two stereo channels (L/R) and delivers the audio data. Concurrently, two audio reproduction devices 20 are set up, and the two audio reproduction devices respectively selects one of the audio data different in those of the stereo channels and outputs each of the data. Further, if a module capable of simultaneously processing a plurality of pieces of digital audio data is adopted as the PLC audio module 121, one PLC audio module 121 can process the plurality of pieces of the digital audio data. Accordingly, each of the audio delivery device 10 and the audio reproduction device 20 can have a simpler configuration.

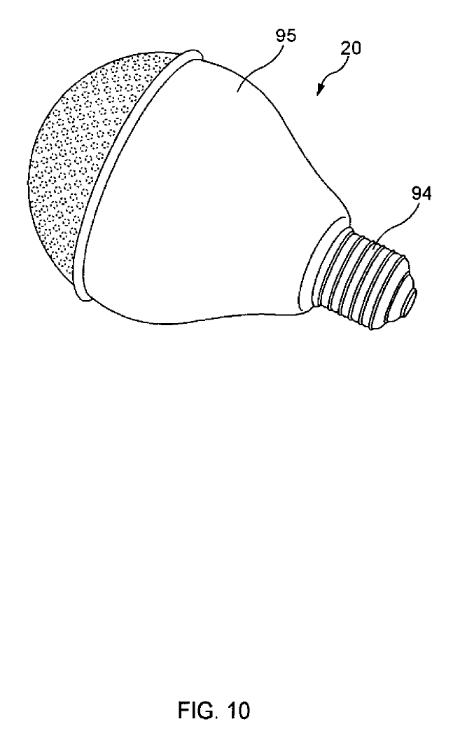

Furthermore, the audio reproduction device 20 can have a configuration that, for example, the PLC unit 21, the microcomputer 22 and the decoder unit 23 which have been described above are stored in a speaker box 90 as shown in FIG. 9 (hereinafter, referred to as a “built-in speaker box type configuration”). By adopting this configuration, an audio cable for connecting the speaker 24 to the power amplifier 233 is unnecessary in setting up the audio reproduction device 20, and accordingly, the audio reproduction device 20 can be easily set up only by connecting a plug thereof to an electric outlet.

FIG. 10 shows another example of the configuration of the audio reproduction device 20 of the built-in speaker box type. The audio reproduction device 20 shown in FIG. 10 has an exterior appearance which looks like a commercial light bulb such as a PS light bulb. A base 94 formed of a conductive material is a part which has a standard shape and is attachable to a standard shaped bulb socket which is connected to the power line 50. The PLC unit 21, the microcomputer 22, the decoder unit 23 and the speaker 24, which have been described above, are stored inside a cabinet 95 which is a bulb-shaped speaker box and is connected to the base 94. In this way, since the audio reproduction device 20 has the exterior appearance similar to that of a commercial light bulb, it is possible to easily set the audio reproduction device 20 to a lighting apparatus such as a floor lamp by use of the method entirely same as that used for attaching a commercial light bulb to the floor lamp. Note that the shape of the cabinet 95 is not necessarily limited to the shape shown in FIG. 10.

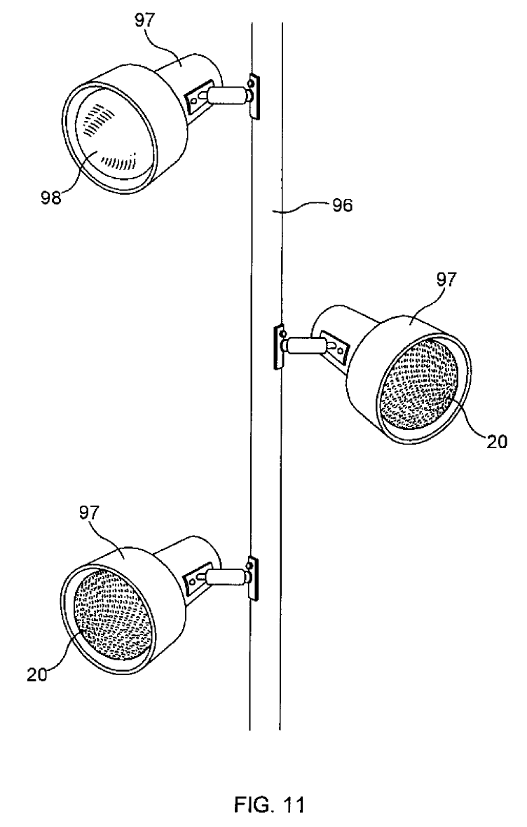

FIG. 11 shows a state where audio reproduction devices 20 each having the exterior appearance shown in FIG. 10 are attached to a floor lamp 96 having a plurality of bulb sockets 97. In this regard, as in the case of the floor lamp 96 shown in FIG. 11, some of the audio reproduction devices 20 can be attached to some of the bulb sockets 97 and commercial bulbs 98 can be attached to the remaining other bulb sockets 97. Accordingly, the audio reproduction devices 20 can be provided while the floor lamp 96 keeps functioning as a lighting apparatus.

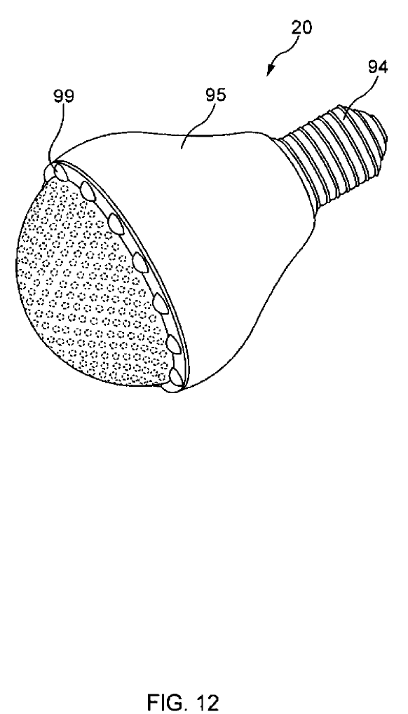

It does not matter that the lighting function is provided to the audio reproduction device 20 itself. FIG. 12 is an example of the audio reproduction device 20 of the built-in speaker box type which is provided with the lighting function. The audio reproduction device 20 shown in FIG. 12 has a cabinet 95 which has a shape of a cone in which top part of the cone is cut. A plurality of LEDs (light emitting diodes) 99 is provided as light emitting elements along a circumference direction on a bottom surface opposite to the base 94. Voltages for driving the LEDs 99 is supplied from a power supply circuit 122 stored in the cabinet 95. With respect to this audio reproduction device 20, even in a case of, for example, a floor lamp 96 having only one bulb socket 97, it is possible to set the audio reproduction device 20 while maintaining the lighting function.

The above-described audio system 1 is a system in which digital audio data are supplied to the PLC unit 12 by the information processing unit 11 such as a personal computer. However, it is also possible to adopt a configuration of the system that the digital audio data are supplied due to sounds outputted from a stationary or a portable device, which has an analog audio output terminal, such as a commercial CD player, MD player or hard disk player (hereinafter, referred to as an “analog audio device”) other than the information processing device 11.

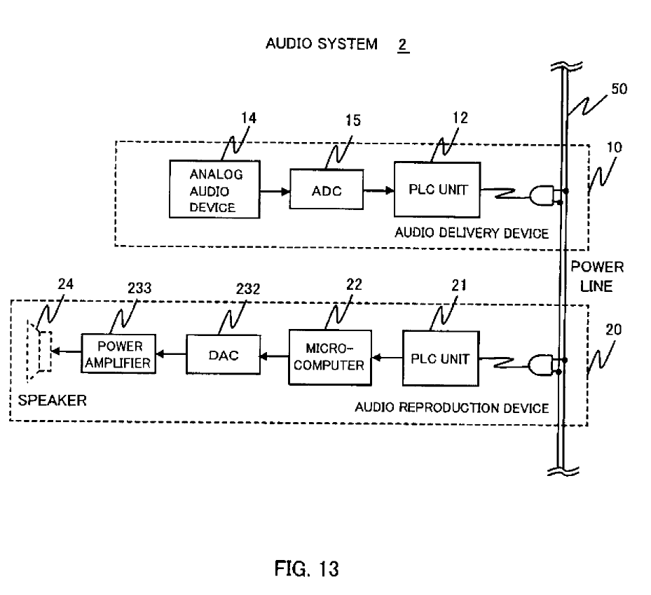

FIG. 13 shows an example of an audio system 2 in which digital audio data are supplied by an analog audio device. As shown in FIG. 13, in place of the information processing device 11, an audio delivery device 10 includes an analog audio device 14 and an A/D converter 15. The A/D converter 15 converts analog audio signals, which are outputted from the analog audio device 14, into digital audio data to be inputted to a PLC unit 12 (for example, non-compressed data in linear PCM (Pulse Coded Modulation) format). In addition, an audio reproduction device 20 includes a D/A converter 232 in place of the above-described decoder unit 23. The D/A converter 232 converts the digital audio data, which are inputted in the bitstream format from a PLC unit 21 by a microcomputer 22, into analog audio data. As described, it is also possible to configure the audio system using power line communications by use of the analog audio device 14 in place of the information processing device 11.

Heretofore, the detailed descriptions have been provided for the preferred specific examples of the invention. However, it should be understood that various modifications and alternations can be adopted without being apart from the spirit and scope of the invention which are defined by the attached claims.

What is claimed is:

1. An audio reproduction device comprising:
a PLC unit for receiving communications signals of power line communications transmitted through a power line and outputting digital audio data included in the communications signals;
an audio signal generation circuit for generating analog audio signals based on the digital audio data;
a power supply circuit for generating a drive voltage for each of the PLC unit and the audio signal generation circuit based on a commercial power supplied from the power line; and
a speaker for outputting sounds based on the analog audio signals.

2. The audio reproduction device according to claim 1, wherein the audio signal generation circuit includes
a decoder for decoding the digital audio data; and
a D/A converter for generating the analog audio signals based on the digital data having been decoded by the decoder.

3. The audio reproduction device according to claim 1, wherein the audio signal generation circuit includes a D/A converter for generating the analog audio signals based on the digital audio data.

4. The audio reproduction device according to claim 1, wherein the audio signal generation circuit includes a power amplifier for amplifying the analog audio signals and outputting the amplified analog audio signals to the speaker.

5. The audio reproduction device according to claim 1,
wherein a plurality of pieces of multiplex digital audio data are multiplexed on the communication signals;
identifiers respectively specifying the plurality of pieces of the digital audio data are attached thereto; and
the audio signal generation circuit includes a circuit for selecting a specific piece of the digital audio data attached with a specific one of the identifiers, thus generating analog audio signals of the specific piece of the digital audio data.

6. The audio reproduction device according to claim 1,
wherein a plurality of pieces of multiplex digital audio data are multiplexed on the communication signals; and
the PLC unit is capable of outputting the plurality of pieces of the digital audio data included in the communications signals.

7. The audio reproduction device according to claim 1, further comprising a speaker box in which the PLC unit, the audio signal generation circuit, the power supply circuit and the speaker are provided.

8. The audio reproduction device according to claim 7, wherein the speaker box is provided with light emission elements.

9. The audio reproduction device according to claim 7, wherein the speaker box includes a base attachable to a bulb socket which has a standard shape and is connected to the power line.

10. The audio reproduction device according to claim 9, wherein the speaker box has a shape of a bulb connected to the base integrally.

11. The audio reproduction device according to claim 1, further comprising:
a speaker box in which the speaker is provided,
wherein the speaker box is provided with light emission elements.

12. The audio reproduction device according to claim 1, further comprising:
a speaker box in which the speaker is provided,
wherein the speaker box includes the base attachable to a bulb socket which has a standard shape and is connected to the power line.

13. The audio reproduction device according to claim 12,
wherein the speaker box has a shape of a bulb connected to the base integrally.

14. An audio system, comprising:
an audio delivery device for outputting digital audio data as communications signals of power line communications to a power line; and
an audio reproduction device for receiving the communications signals transmitted through the power line and generating analog audio signals based on the digital audio data included in the received communications signals.

15. The audio system according to claim 14,
wherein the audio reproduction device includes an input device for accepting an operation input relating to an audio reproduction;
the audio reproduction device outputs contents of the operation input as commutations signals of power line communications to the power line; and
the audio delivery device receives the communications signals and controls the audio reproduction in response to the contents of the operation input, the contents being included in the received communications signals.

16. The audio system according to claim 15, wherein the input device receives the contents of the operation input, which contents are transmitted by radio from a remote controller, and outputs the received contents of the operation input as the communications signal to the power line.

17. An audio delivery device for outputting digital audio data as communications signals of power line communications to a power line in an audio system that includes a audio reproduction device for receiving the communications signals transmitted through the power line and generates analog audio signals based on the digital audio data included in the received communications signals,
the audio delivery device comprising:
a socket for connecting an information processing device, which supplies the digital audio data, to a PLC unit, which outputs the digital audio data as communications signals of power line communications to the power line, in order that the information processing device is capable of communicating with the PLC unit.

18. The audio delivery device according to claim 17, further comprising:
a charging circuit for charging, through the socket, a secondary battery provided to the information processing device.
